(19) United States
(12) Patent Application Publication
(10) Pub. No.: US 2026/0100307 A1
(43) Pub. Date: Apr. 9, 2026

(54) COIL COMPONENT

(71) Applicant: SAMSUNG ELECTRO-MECHANICS CO., LTD., Suwon-si (KR)

(72) Inventors: Joung Hee CHO, Suwon-si (KR); Dong Gun LEE, Suwon-si (KR); Dong Hwi AHN, Suwon-si (KR)

(73) Assignee: SAMSUNG ELECTRO-MECHANICS CO., LTD., Suwon-si (KR)

(21) Appl. No.: 19/234,897

(22) Filed: Jun. 11, 2025

(30) Foreign Application Priority Data
Oct. 8, 2024 (KR) 10-2024-0136829
Dec. 31, 2024 (KR) 10-2024-0201940

(51) Int. Cl. H01F 27/29; H01F 27/06

(52) U.S. Cl. CPC H01F 27/292; H01F 27/06

(57) ABSTRACT

A coil component includes a body and a coil disposed within the body, the coil having a turn formation portion. The coil component further includes a first lead frame connected to a first end of the coil, the first lead frame extending to an outside of the body, and a second lead frame connected to a second end of the coil, the second lead frame also extending to an outside of the body. The coil component is configured such that, when a winding-axis direction of the turn formation portion is defined as a first direction, at least one of the first and second lead frames includes a portion disposed within the body that overlaps the turn formation portion in the first direction.

### CROSS-REFERENCE TO RELATED APPLICATION(S)

This application claims benefit of priority to Korean Patent Application Nos. 10-2024-0136829 and 10-2024-0201940 filed on Oct. 8, 2024 and Dec. 31, 2024 in the Korean Intellectual Property Office, the disclosures of which are incorporated herein by reference in their entirety.

### TECHNICAL FIELD

The present disclosure relates to a coil component.

An inductor, a coil component, is a representative passive electronic component used in electronic devices, along with a resistor and a capacitor.

Recently, the market for high-current power inductors used in AI, automotive electronics, and robotics has been growing rapidly. In particular, automotive components may require high-reliability technology to enhance safety, and may also need to have high-current characteristics and a high level of vibration resistance. In such coil components, a structure in which a coil is welded to a lead frame extending from the inside of the body to the outside of the body is commonly used.

### SUMMARY

An aspect of the present disclosure is to provide a coil component having improved magnetic characteristics while having high structural stability.

According to an aspect of the present disclosure, there is provided a coil component including a body, a coil disposed within the body, the coil including a turn formation portion, a first lead frame connected to a first end of the coil, the first lead frame extending to the outside of the body, and a second lead frame connected to a second end of the coil, the second lead frame extending to the outside of the body. When a winding-axis direction of the turn formation portion is denoted by a first direction, at least one of the first and second lead frames may have at least a portion of a portion, disposed within the body, overlapping the turn formation portion in the first direction.

At least one of the first end and the second end of the coil may overlap at least a portion of the turn formation portion in the first direction.

The first lead frame may include a first connection portion connected to the first end of the coil, and a first lead-out portion extending from the first connection portion to the outside of the body. The second lead frame may include a second connection portion connected to the second end of the coil, and a second lead-out portion extending from the second connection portion to the outside of the body.

The first connection portion may overlap at least a portion of the turn formation portion in the first direction.

The first lead-out portion may not overlap the turn formation portion in the first direction.

The second connection portion may overlap at least a portion of the turn formation portion in the first direction.

The second lead-out portion may not overlap the turn formation portion in the first direction.

The first connection portion and the turn formation portion may have a curved surface.

The first connection portion and the turn formation portion may have substantially the same curvature.

The second connection portion may have a curved surface.

The first connection portion and the turn formation portion may have substantially the same curvature.

The first connection portion may have a shape maintaining a turn of the turn formation portion.

The second connection portion may have a shape maintaining the turn of the turn formation portion.

¼ or more of an area of the first connection portion may overlap the turn formation portion with respect to an area of a plane projected in the first direction.

½ or more of the area of the first connection portion may overlap the turn formation portion with respect to the area of the plane projected in the first direction.

¼ or more of an area of the second connection portion may overlap the turn formation portion with respect to the area of the plane projected in the first direction.

½ or more of the area of the second connection portion may overlap the turn formation portion with respect to the area of the plane projected in the first direction.

The body may have first and second surfaces opposing each other in the first direction. The first and second ends may be disposed to be adjacent to the first surface of the body.

The first and second lead-out portions may extend to the first surface of the body.

The second end of the coil may be disposed to be closer to the center of the turn formation portion than the first end of the coil.

The turn formation portion may form a turn in a direction from the first and second ends of the coil to the second surface of the body.

The first end of the coil may be connected to a surface of the first connection portion facing the first surface of the body.

The second end of the coil may be connected to a surface of the second connection portion facing the first surface of the body.

At least one of the first end and the second end of the coil may not overlap the turn formation portion in the first direction.

The first and second ends of the coil may be disposed on the inside of the turn formation portion.

The first end of the coil may be disposed on the outside of the turn formation portion, and the second end of the coil may be disposed on the inside of the turn formation portion.

The first connection portion and the second connection portion may have different shapes.

The first and second ends of the coil may be disposed on the outside of the turn formation portion.

A line width of each of the first and second connection portions may be greater than a line width of the turn formation portion.

The line width of each of the first and second connection portions may be twice or more the line width of the turn formation portion.

At least one of the first and second connection portions may have a rectangular shape with respect to a shape of a plane projected in the first direction.

The turn formation portion may form a rectangular turn with respect to the shape of the plane projected in the first direction.

According to another aspect of the present disclosure, there is provided a coil component including a body, a coil disposed within the body, the coil including a turn formation portion, a first lead frame connected to a first end of the coil, the first lead frame extending to the outside of the body, and a second lead frame connected to a second end of the coil, the second lead frame extending to the outside of the body. The first lead frame may include a first connection portion connected to the first end of the coil, and a first lead-out portion extending from the first connection portion to the outside of the body. The second lead frame may include a second connection portion connected to the second end of the coil, and a second lead-out portion extending from the second connection portion to the outside of the body. The first connection portion may have a shape maintaining a turn of the turn formation portion.

The second connection portion may have a shape that maintains the turn of the turn formation portion.

The body may have first and second surfaces opposing each other in the first direction, third and fourth surfaces opposing each other in a second direction, perpendicular to the first direction, and fifth and sixth surfaces opposing each other in a third direction, perpendicular to the first and second directions. The first and second lead frames may extend to the first surface of the body, and may be arranged in the second direction.

The first and second ends of the coil may be disposed to be close to a corner at which the fourth and fifth surfaces of the body meet.

The first connection portion and the second connection portion may have different shapes.

According to another aspect of the present disclosure, there is provided a coil component including a body, a coil disposed within the body, the coil including a turn formation portion, a first lead frame connected to a first end of the coil, the first lead frame extending to the outside of the body, and a second lead frame connected to a second end of the coil, the second lead frame extending to the outside of the body. At least one of the first and second ends of the coil may be disposed on the inside of the turn formation portion.

The first and second ends of the coil may be disposed on the inside of the turn formation portion.

The first end of the coil may be disposed on the inside of the turn formation portion, and the second end of the coil may be disposed on the outside of the turn formation portion.

According to example embodiments of the present disclosure, a coil component may have improved magnetic characteristics while having high structural stability.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic transmission perspective view of a coil component according to an example embodiment of the present disclosure;

FIG. 2 is a cross-sectional view of a region of the coil component of FIG. 1;

FIG. 3 is a plan view of the coil component of FIG. 1, viewed in one direction;

FIG. 4 is a plan view of the coil component of FIG. 1, viewed in a different direction;

FIG. 5 is a plan view of a coil component according to another example embodiment, viewed in one direction;

FIG. 6 is a plan view of the coil component of FIG. 5, viewed in a different direction;

FIG. 7 is a plan view of a coil component according to another example embodiment, viewed in one direction;

FIG. 8 is a plan view of the coil component of FIG. 7, viewed in a different direction;

FIG. 9 is a plan view of a coil component according to another example embodiment, viewed in one direction;

FIG. 10 is a plan view of the coil component of FIG. 9, viewed in a different direction;

FIG. 11 is a plan view of a coil component according to another example embodiment, viewed in one direction;

FIG. 12 is a plan view of a coil component according to another example embodiment, viewed in one direction;

FIG. 13 is a plan view of a coil component according to another example embodiment, viewed in one direction; and

FIG. 14 is a plan view of a coil component according to another example embodiment, viewed in one direction.

### DETAILED DESCRIPTION

Hereinafter, example embodiments of the present disclosure are described with reference to specific example embodiments and accompanying drawings. The present disclosure may, however, be exemplified in many different forms and should not be construed as being limited to the specific example embodiments set forth herein. In addition, example embodiments of the present disclosure may be provided for a more complete description of the present disclosure to those skilled in the art. Accordingly, the shapes and sizes of the elements in the drawings may be exaggerated for clarity of description, and elements denoted by the same reference numerals in the drawings may be the same elements.

Various types of electronic components may be used in electronic devices, and various types of coil components may be appropriately used between such electronic components to remove noise. That is, in an electronic device, a coil component may be used as a power inductor, a high frequency (HF) inductor, a general bead, a high-frequency bead (GHz bead), a common mode filter, or the like.

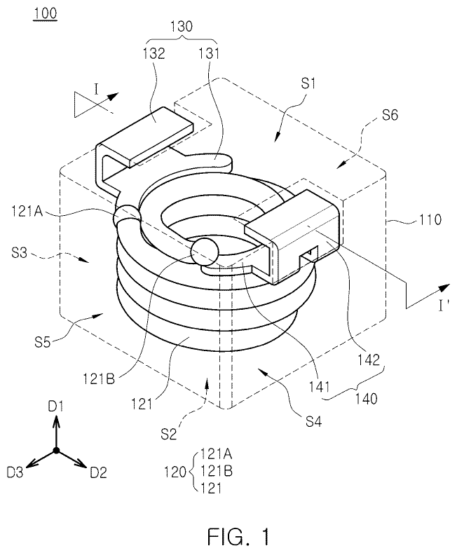

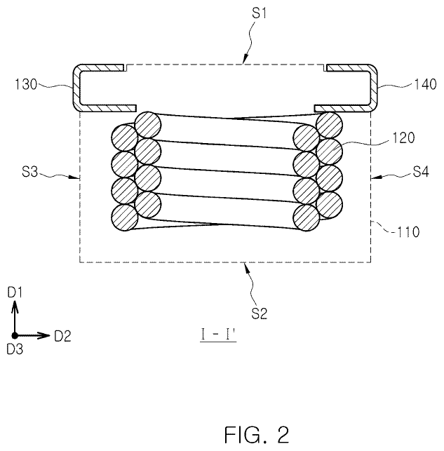

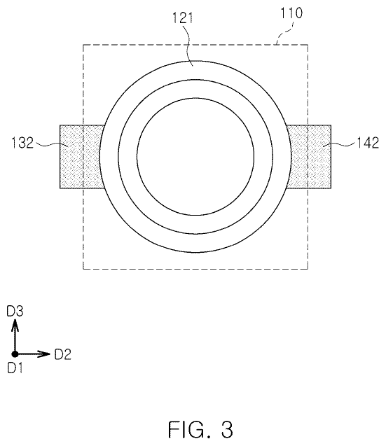

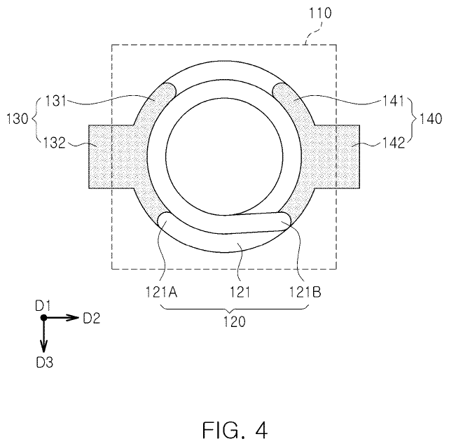

FIG. 1 is a schematic transmission perspective view of a coil component according to an example embodiment of the present disclosure. FIG. 2 is a cross-sectional view of a region of the coil component of FIG. 1. FIG. 3 is a plan view of the coil component of FIG. 1, viewed in one direction (a direction from bottom to top in FIG. 1). FIG. 4 is a plan view of the coil component of FIG. 1, viewed in a different direction (a direction from top to bottom in FIG. 1). Referring to FIGS. 1 to 4, a coil component 100 according to the present example embodiment may include a body 110, a coil 120, a first lead frame 130, and a second lead frame 140, and at least one of the first and second lead frames 130 and 140 may have at least a portion of a portion, disposed within the body 110, overlapping at least a portion of a turn formation portion 121 of the coil 120 in a first direction D1 corresponding to a winding axis direction. A structure in which the lead frames 130 and 140 and the coil 120 overlap each other may reduce pressure applied to the coil 120 and the lead frames 130 and 140 during a molding process of the body 110, thereby improving structural stability of the coil component 100. In addition, a size or the number of turns, formed by the turn formation portion 121 of the coil 120, may be effectively increased. In addition, a portion of the lead frames 130 and 140 may form a turn, thereby improving magnetic characteristics of the coil component 100 such as Ls characteristics or the like. Details thereof will be described below. Hereinafter, main elements included in the coil component 100 according to the present example embodiment will be described. In the drawings, the first direction D1 may be defined as a winding-axis direction of the turn formation portion 121, a second direction D2 may be defined as a direction, perpendicular to the first direction D1, and a third direction D3 may be defined as a direction, perpendicular to both the first direction D1 and the second direction D2.

The body 110 may include a coil 120 or the like disposed therein to form the overall exterior of the coil component 100. In this case, the body 110 may have a first surface S1 and a second surface S2 opposing each other in the first direction D1, and the first surface S1 and the second surface S2 may respectively correspond to upper and lower surfaces of the body 110 in FIG. 1. The body 110 may have the plurality of side surfaces connecting the first surface S1 and the second surface S2 to each other. Here, the plurality of side surfaces may include a third surface S3 and a fourth surface S4 opposing each other in the second direction D2, a fifth surface S5 and a sixth surface S6 opposing each other in the third direction D3. The body 110 may include an insulating resin and a magnetic material. Specifically, the body 110 may be formed by laminating one or more magnetic composite sheets in which the magnetic material is dispersed in the insulating resin. As a specific example, the body 110 may be formed by implementing an insulating resin and a magnetic material in the form of a mold, disposing the coil 120 and lead frames 130 and 140 therein, and then curing the same.

The magnetic material included in the body 110 may be ferrite powder particles or metal magnetic powder particles. The ferrite powder particles may be, for example, at least one of spinel-type ferrite powder particles such as Mg—Zn-based ferrite powder particles, Mn—Zn-based ferrite powder particles, Mn—Mg-based ferrite powder particles, Cu—Zn-based ferrite powder particles, Mg—Mn—Sr-based ferrite powder particles, Ni—Zn-based ferrite powder particles, or the like, hexagonal ferrite powder particles such as Ba—Zn-based ferrite powder particles, Ba—Mg-based ferrite powder particles, Ba—Ni-based ferrite powder particles, Ba—Co-based ferrite powder particles, Ba—Ni—Co-based ferrite powder particles, or the like, garnet-type ferrite powder particles such as Y-based ferrite powder particles or the like, and Li-based ferrite powder particles. The magnetic metal powder particles may be amorphous or crystalline. For example, the magnetic metal powder particles may be Fe—Si—B—Cr-based amorphous alloy powder particles, but the present disclosure is not limited thereto. Each of the ferrite powder particles and the magnetic metal powder particles may have an average diameter of about 0.1 μm to about 30 μm, but the present disclosure is not limited thereto. The body 110 may include two or more types of magnetic materials dispersed in the resin. Here, different types of magnetic materials mean that the magnetic materials dispersed in the resin are distinguished from each other by one of an average diameter, a composition, crystallinity, and a shape. The insulating resin may include epoxy, polyimide, a liquid crystal polymer, or the like alone or in combination, but the present disclosure is not limited thereto.

The coil 120 may be disposed within the body 110 to exhibit characteristics of the coil component 100. For example, when the coil component 100 according to the present example embodiment is used as a power inductor, the coil 120 may serve to stabilize power of an electronic device by storing an electric field as a magnetic field and maintaining an output voltage. The coil 120 may include a turn formation portion 121. Here, the turn formation portion 121 may form at least one turn with respect to a winding axis of the first direction D1. As illustrated in the drawings, the turn formation portion 121 may be wound in an overall circular or oval shape, and may be positioned between a first end 121A and a second end 121B of the coil 120 to be connected to the first end 121A and the second end 121B. In addition, the first and second ends 121A and 121B of the coil 120 may be connected to the first and second lead frames 130 and 140 in the body 110, respectively. As a specific example, the first and second ends 121A and 121B may be coupled to the first and second lead frames 130 and 140 respectively through welding or the like. As illustrated in the drawings, the first and second ends 121A and 121B may have a width or thickness greater than that of the turn formation portion 121 for stable connection. The coil 120 may be an air core coil, and may be formed using a metal wire having a circular cross-section. Alternatively, a cross-sectional shape of the coil 120 may be deformed to a rectangular shape or the like. The coil 120 may be formed by winding a conductive metal, and a remaining portion of the coil, excluding portions in contact with the lead frames 130 and 140, may be coated with an insulating coating layer. Specifically, the coil 120 may be formed by winding a metal wire such as a copper wire including a metal wire and an insulating coating layer covering a surface of the metal wire in a spiral shape.

The first lead frame 130 may be connected to the first end 121A of the coil 120 in the body 110, and may extend to the outside of the body 110. In addition, the second lead frame 140 may be connected to the second end 121B of the coil 120 in the body 110, and may extend to the outside of the body 110. Due to such a structure, the first and second lead frames 130 and 140 may serve as external electrodes of the coil component 100. In this case, the first and second lead frames 130 and 140 may be arranged in the second direction D2 while extending to the first surface S1 of the body 110, and may be disposed on the third surface S3 and fourth surface S4 of the body 110, respectively. The first lead frame 130 may include a first connection portion 131 connected to the first end 121A, and a first lead-out portion 132 extending from the first connection portion 131 to the outside of the body 110. In addition, the second lead frame 140 may include a second connection portion 141 connected to the second end 121B, and a second lead-out portion 142 extending from the second connection portion 141 to the outside of the body 110. In this case, the first and second lead-out portions 132 and 142 may extend to the first surface S1 of the body 110. More specifically, the first and second lead-out portions 132 and 142 may be bent toward the first surface S1 of the body 110. The first and second lead frames 130 and 140 may include a metal such as Ag, Ag—Pd, Ni, Cu, or the like, and a Ni plating layer and an Sn plating layer may be selectively formed on surfaces of the first and second lead frames 130 and 140.

As described above, at least one of the first and second lead frames 130 and 140 may have at least a portion of a portion, disposed within the body 110, overlapping at least a portion of the turn formation portion 121 of the coil 120 in the first direction D1. In the present example embodiment, both the first and second lead frames 130 and 140 may overlap at least a portion of the turn formation portion 121. However, only one of the first and second lead frames 130 and 140 may overlap at least a portion of the turn formation portion 121. When the lead frames 130 and 140 overlap the turn formation portion 121, the effect caused by pressure applied to the coil 120 and the lead frames 130 and 140, for example, pressure applied to the lead frames 130 and 140 in the first direction D1, during the molding process of the body 110 may be reduced. When the lead frames 130 and 140 and the turn formation portion 121 do not have an overlapping region, pressure may be applied to each of the coil 120 and the lead frames 130 and 140 during the molding process, causing deformation. In addition, a magnetic particle filling rate of the body 110 may change significantly in a region around the lead frames 130 and 140, and imbalance of the filling rate may be reduced by allowing the lead frames 130 and 140 and the coil 120 to overlap each other. In addition, when the lead frames 130 and 140 and the turn formation portion 121 overlap each other, a size or the number of turns of the turn formation portion 121 of the coil 120 may be effectively increased. In addition, a portion of the lead frames 130 and 140 may form a turn and thus magnetic characteristics of the coil component 100, such as Ls characteristics or the like, may be improved.

In order to enlarge such an overlapping structure, at least one of the first end 121A and the second end 121B of the coil 120 may overlap at least a portion of the turn formation portion 121 in the first direction D1. In the present example embodiment, both the first end 121A and the second end 121B of the coil 120 may overlap at least a portion of the turn formation portion 121 in the first direction D1. However, only one of the first end 121A and the second end 121B of the coil 120 may overlap the turn formation portion 121.

A structure of the first and second lead frames 130 and 140 may suitably overlap the turn formation portion 121. In addition, a structure of the first and second lead frames 130 and 140 may suitably form a portion of a turn in a magnetic component 100. Specifically, the first connection portion 131 of the first lead frame 130 may overlap at least a portion of the turn formation portion 121 in the first direction D1. Alternatively, the first lead-out portion 132 may not overlap the turn formation portion 121 in the first direction D1. Similarly, the second connection portion 141 of the second lead frame 140 may overlap at least a portion of the turn formation portion 121 in the first direction D1. Alternatively, the second lead-out portion 142 may not overlap the turn formation portion 121 in the first direction D1.

As illustrated in the drawings, the first connection portion 131 of the first lead frame 130 may have a curved surface, and the turn formation portion 121 may have a curved surface. As a specific example, a side surface of the first connection portion 131 and a side surface of the turn formation portion 121 may be a curved surface, respectively. In this case, the first connection portion 131 and the turn formation portion 121 may have substantially the same curvature. Similarly, the second connection portion 141 of the second lead frame 140 may have a curved surface. As a specific example, a side surface of the second connection portion 141 may be a curved surface. In this case, the second connection portion 141 and the turn formation portion 121 may have substantially the same curvature. As the first and second connection portions 131 and 141 form a turn to have a curvature substantially the same as that of the turn formation portion 121, the first and second connection portions 131 and 141 may suitably form an additional turn.

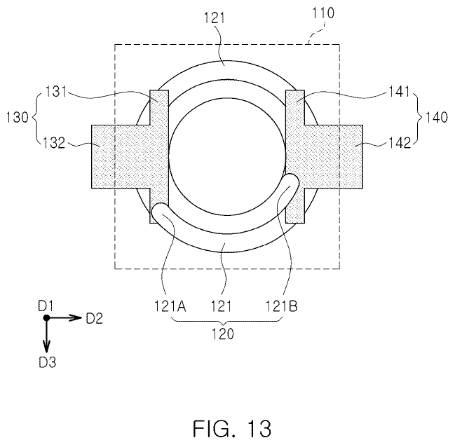

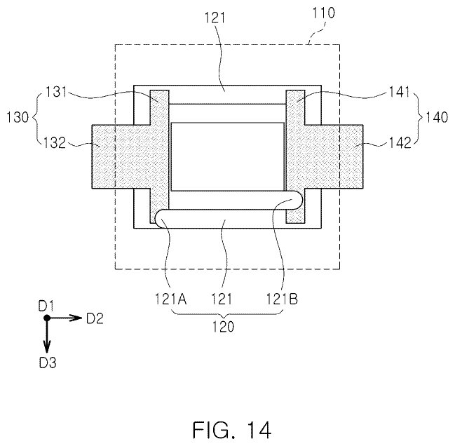

As a more specific example, the first connection portion 131 may have a shape maintaining a turn of the turn formation portion 121. Here, maintaining the turn of the turn formation portion 121 may mean that a turn extending from the second end 121B to the first end 121A continuously extends even in the turn formation portion 121. Similarly, the second connection portion 141 may have a shape maintaining the turn of the turn formation portion 121. Specifically, a turn extending from the first end 121A to the second end 121B may continuously extend even in the turn formation portion 121. An additional turn, formed by the first connection portion 131 as described above, may be greater than or equal to ¼ turn and less than or equal to ½ turn. Similarly, an additional turn, formed by the second connection portion 141, may be greater than or equal to ¼ turn and less than or equal to ½ turn. As in the present example embodiment, when the first and second connection portions 131 and 141 maintain the turn of the turn formation portion 121, a core area of the turn formation portion 121 may be effectively increased. In addition, pressure, applied to the coil 120 and the lead frames 130 and 140 during the molding process of the body 110, may be minimized. However, a case in which the first and second connection portions 131 and 141 maintain the turn of the turn formation portion 121 may not mean a case in which the first and second connection portions 131 and 141 have a curvature substantially as the same that of the turn formation portion 121. As long as the turn formation portion 121 does not proceed in a direction opposite to a turning direction, an overall structure in which the turn of the turn formation portion 121 continuously extends shall be encompassed. For example, the example embodiments illustrated in FIGS. 13 and 14 shall also be included within the scope of the present disclosure.

When the lead frames 130 and 140 and the turn formation portion 120 overlap each other in a wide region, it may be suitable for obtaining intended effects in the present example embodiment. However, a degree of overlapping may be determined in consideration of characteristics such as an intended design method or inductance. For example, ¼ or more an area of the first connection portion 131 may overlap the turn formation portion 121 with respect to an area of a plane projected in the first direction D1. More specifically, ½ or more of the area of the first connection portion 131, more specifically ¾ or more of the area of the first connection portion 131 may overlap the turn formation portion 121 with respect to the area of the plane projected in the first direction D1. Similarly, ¼ or more of an area of the second connection portion 141 may overlap the turn formation portion 121 with respect to the area of the plane projected in the first direction D1. More specifically, ½ and more of the area of the second connection portion 141, more specifically, ¾ or more of the area of the second connection portion 141 may overlap the turn formation portion 121 with respect to the area of the plane projected in the first direction D1.

In more detail, the forms of the coil 120 and the lead frames 130 and 140 may be described in more detail. As illustrated in FIGS. 1 and 2, the first and second ends 121A and 121B of the coil 120 may be disposed to be adjacent to the first surface S1 of the body 110. In this case, the first and second lead-out portions 132 and 142 may extend to the first surface S1 of the body 110. Thus, a path between the lead frames 130 and 140 and the coil 120 may be reduced, thereby reducing electrical resistance. With respect to a form in which the coil 120 is wound, the second end 121B may be disposed to be closer to the center or a winding axis of the turn formation portion 121 than the first end 121A. In addition, the turn formation portion 121 may form a turn in a direction from the first and second ends 121A and 121B to the second surface S2 of the body 110. In addition, the first end 121A may be connected to a surface of the first connection portion 131 facing the first surface S1 of the body 110, and the second end 121B may be connected to a surface of the second connection portion 141 facing the first surface S1 of the body 110.

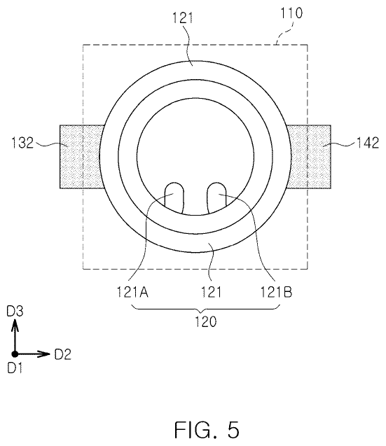

Subsequently, coil components according to modifications will be described with reference to FIGS. 5 to 12, based on specific forms of the coil 120 and the lead frames 130 and 140. The above-described basic embodiment and some structures and functions may be modified; however, structural stability and magnetic characteristics of the coil component 100 may be improved even in the modified example embodiments.

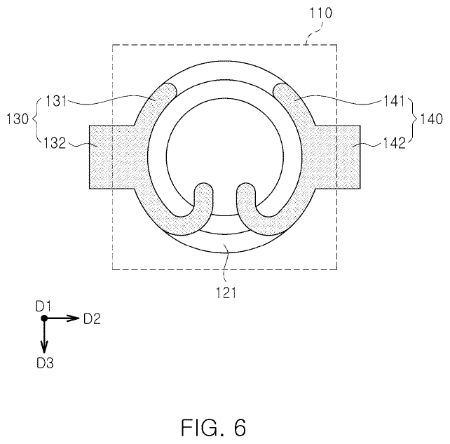

First, FIGS. 5 and 6 are plan views of coil components viewed in opposite directions, and FIG. 5 may correspond to FIG. 3 and FIG. 6 may correspond to FIG. 4. In the example embodiments of FIGS. 5 and 6, unlike the previous example embodiment, at least one of a first end 121A and a second end 121B of a coil 120 may not overlap a turn formation portion 121 in a first direction D1. In FIGS. 5 and 6, the first end 121A and the second end 121B of the coil 120 may not overlap the turn formation portion 121 in the first direction D1. Alternatively, one of the first end 121A and the second end 121B of the coil 120 may overlap the turn formation portion 121 in the first direction D1, and the other one may not overlap the turn formation portion 121 in the first direction D1. As illustrated in the drawings, the first and second ends 121A and 121B may be disposed on the inside of the turn formation portion 121. As in the present example embodiment, when the first and second ends 121A and 121B are disposed on the inside of the turn formation portion 121, a core area of the turn formation portion 121 may be slightly reduced. However, a process (for example, welding) for bonding the coil 120 to the lead frames 130 and 140 may be efficiently performed.

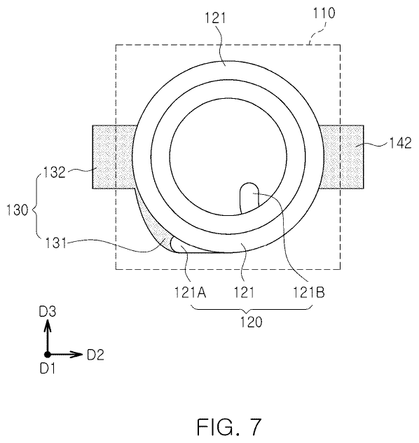

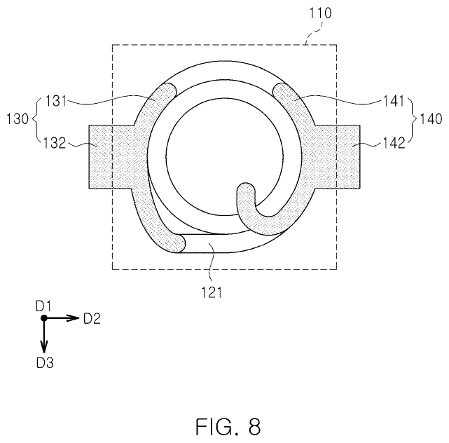

Subsequently, FIGS. 7 and 8 are plan views of coil components viewed in opposite directions, and FIG. 7 may correspond to FIG. 3 and FIG. 8 may correspond to FIG. 4. In the example embodiments of FIGS. 7 and 8, a first end 121A may be disposed on the inside of a turn formation portion 121, and a second end 121B may be disposed on the outside of the turn formation portion 121. As illustrated in the drawings, due to such an arrangement, a first connection portion 131 and a second connection portion 141 may have different shapes. The arrangement may minimize bending of the coil 120, thereby increasing efficiency in a manufacturing process of the coil 120 and improving electrical characteristics of the coil 120.

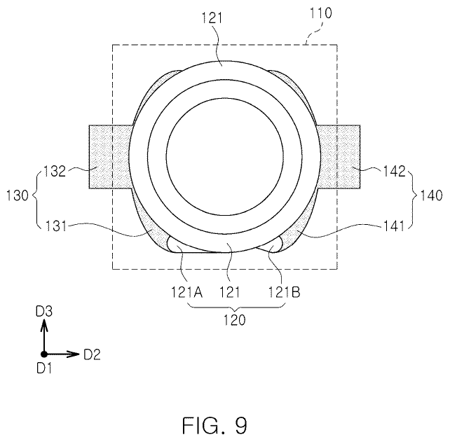

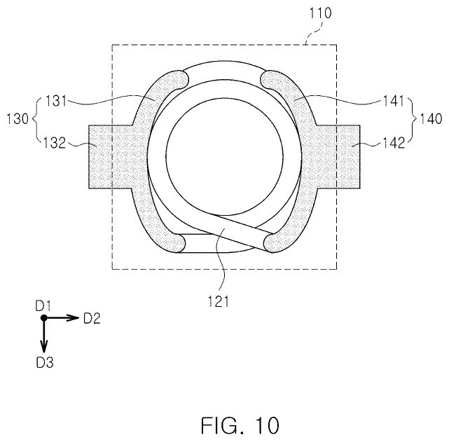

Subsequently, FIGS. 9 and 10 are plan views of coil components viewed in opposite directions, and FIG. 9 may correspond to FIG. 3 and FIG. 10 may correspond to FIG. 4. In the example embodiments of FIGS. 9 and 10, first and second ends 121A and 121B may be disposed on the outside of a turn formation portion 121. As in the present example embodiment, when the first and second ends 121A and 121B are disposed on the outside of the turn formation portion 121, a process (for example, welding) for bonding a coil 120 and lead frames 130 and 140 to each other may be efficiently performed while maximizing a core area of the turn formation portion 121.

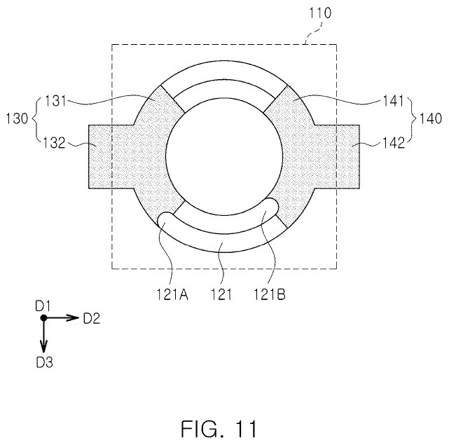

FIG. 11 is a plan view of a coil component according to another example embodiment, viewed in one direction, and may correspond to FIG. 4. In the example embodiment of FIG. 11, a line width of each of first and second connection portions 131 and 141 may be greater than a line width of a turn formation portion 121. As a specific example, the line width of each of the first and second connection portions 131 and 141 may be twice or more the line width of the turn formation portion 121. FIG. 11 illustrates a case in which the line width of each of the first and second connection portions 131 and 141 is twice the line width of the turn formation portion 121, and the line width of each of the first and second connection portions 131 and 141 may be three or four times the line width of the turn formation portion 121, or the line width of each of the first and second connection portions 131 and 141 may be five times the line width of the turn formation portion 121. The line width of each of the first and second connection portions 131 and 141 and the turn formation portion 121 may be a line width of each turn measured by the first and second connection portions 131 and 141 and the turn formation portion 121 in a third direction D3 with respect to an optical microscope image or an SEM image of a cross-section in a second direction D2 and a third direction D3 obtained by cutting a central portion of the coil 120 in the first direction D1, and may refer to an average value of values measured in at least three regions.

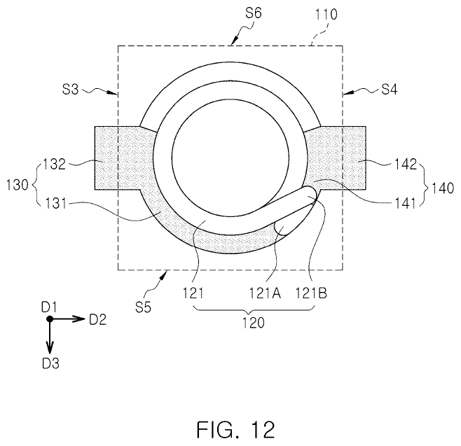

FIG. 12 is a plan view of a coil component according to another example embodiment, viewed in one direction, and may correspond to FIG. 4. In the example embodiment of FIG. 12, first and second ends 121A and 121B of a coil 120 may be disposed to be close to a corner at which fourth and fifth surfaces S4 and S5 of a body 110 meet. In this case, the first and second connection portions 121A and 121B may have different shapes. The coil 120 and the connection portions 121A and 121B may have a structure the same as that in the present example embodiment. Accordingly, the coil 120 and the connection portions 121A and 121B may form an overall turn in one direction, and a wasted turn may be minimized.

In the above-described example embodiment, the coil 120 and the connection portions 121A and 121B may have a curved shape having a curvature with respect to a shape of a plane projected in a first direction D1, but the shape is not limited to the curved shape. FIGS. 13 and 14 are plan views of coil components according to different example embodiments, viewed in one direction, and may correspond to FIG. 4. First, as in the example embodiment of FIG. 13, at least one of the first and second connection portions 121A and 121B may have a rectangular shape with respect to the shape of the plane projected in the first direction D1. FIG. 13 illustrates an example in which both the first and second connection portions 121A and 121B have a rectangular shape with respect to the shape of the plane projected in the first direction D1, but one of the first and second connection portions 121A and 121B may have a rectangular shape. In this case, as in the example embodiment of FIG. 14, the turn formation portion 121 may form a rectangular turn with respect to the shape of the plane projected in the first direction D1.

While example embodiments have been shown and described above, it will be apparent to those skilled in the art that modifications and variations could be made without departing from the scope of the present disclosure as defined by the appended claims.

What is claimed is:

1. A coil component comprising:
a body;
a coil disposed within the body, the coil including a turn formation portion;
a first lead frame connected to a first end of the coil, the first lead frame extending to an outside of the body; and
a second lead frame connected to a second end of the coil, the second lead frame extending to the outside of the body,
wherein, when a winding-axis direction of the turn formation portion is denoted by a first direction, at least one of the first and the second lead frames has a portion, disposed within the body, overlapping the turn formation portion in the first direction.

2. The coil component of claim 1, wherein at least one of the first end and the second end of the coil overlaps at least a portion of the turn formation portion in the first direction.

3. The coil component of claim 1, wherein
the first lead frame includes a first connection portion connected to the first end of the coil, and a first lead-out portion extending from the first connection portion to the outside of the body, and
the second lead frame includes a second connection portion connected to the second end of the coil, and a second lead-out portion extending from the second connection portion to the outside of the body.

4. The coil component of claim 3, wherein the first connection portion overlaps at least a portion of the turn formation portion in the first direction.

5. The coil component of claim 4, wherein the first lead-out portion does not overlap the turn formation portion in the first direction.

6. The coil component of claim 4, wherein the second connection portion overlaps at least a portion of the turn formation portion in the first direction.

7. The coil component of claim 6, wherein the second lead-out portion does not overlap the turn formation portion in the first direction.

8. The coil component of claim 3, wherein the first connection portion and the turn formation portion each have a curved surface.

9. The coil component of claim 8, wherein the first connection portion and the turn formation portion have substantially the same curvature.

10. The coil component of claim 8, wherein the second connection portion has a curved surface.

11. The coil component of claim 10, wherein the second connection portion and the turn formation portion have substantially the same curvature.

12. The coil component of claim 3, wherein the first connection portion has a shape that maintains a turn of the turn formation portion.

13. The coil component of claim 12, wherein the second connection portion has a shape that maintains the turn of the turn formation portion.

14. The coil component of claim 3, wherein at least ¼ of an area of the first connection portion overlaps the turn formation portion with respect to an area of a plane projected in the first direction.

15. The coil component of claim 14, wherein at least ½ of the area of the first connection portion overlaps the turn formation portion with respect to the area of the plane projected in the first direction.

16. The coil component of claim 14, wherein at least ¼ of an area of the second connection portion overlaps the turn formation portion with respect to the area of the plane projected in the first direction.

17. The coil component of claim 16, wherein at least ½ of the area of the second connection portion overlaps the turn formation portion with respect to the area of the plane projected in the first direction.

18. The coil component of claim 1, wherein
the body has first and second surfaces opposing each other in the first direction, and
the first and the second ends are disposed to be adjacent to the first surface of the body.

19. The coil component of claim 18, wherein first and second lead-out portions extend to the first surface of the body.

20. The coil component of claim 18, wherein the second end of the coil is disposed to be closer to a center of the turn formation portion than the first end of the coil.

21. The coil component of claim 20, wherein the turn formation portion forms a turn in a direction from the first and the second ends of the coil to the second surface of the body.

22. The coil component of claim 18, wherein the first end of the coil is connected to a surface of the first connection portion facing the first surface of the body.

23. The coil component of claim 22, wherein the second end of the coil is connected to a surface of the second connection portion facing the first surface of the body.

24. The coil component of claim 1, wherein at least one of the first end and the second end of the coil does not overlap the turn formation portion in the first direction.

25. The coil component of claim 24, wherein the first and second ends of the coil are positioned inside the turn formation portion.

26. The coil component of claim 24, wherein the first end of the coil is disposed on an outside of the turn formation portion, and the second end of the coil is positioned inside the turn formation portion.

27. The coil component of claim 24, wherein the first connection portion and the second connection portion have different shapes.

28. The coil component of claim 24, wherein the first and second ends of the coil are disposed on an outside of the turn formation portion.

29. The coil component of claim 1, wherein each of the first and the second connection portions has a line width greater than a line width of the turn formation portion.

30. The coil component of claim 29, wherein the line width of each of the first and second connection portions is at least twice the line width of the turn formation portion.

31. The coil component of claim 1, wherein at least one of the first and the second connection portions has a rectangular shape when viewed in a plane projected along the first direction.

32. The coil component of claim 31, wherein the turn formation portion forms a rectangular turn shape when viewed in a plane projected along the first direction.

33. A coil component comprising:
a body;
a coil disposed within the body, the coil including a turn formation portion;
a first lead frame connected to a first end of the coil, the first lead frame extending to an outside of the body; and
a second lead frame connected to a second end of the coil, the second lead frame extending to the outside of the body,
wherein the first lead frame includes a first connection portion connected to the first end of the coil, and a first lead-out portion extending from the first connection portion to the outside of the body,
the second lead frame includes a second connection portion connected to the second end of the coil, and a second lead-out portion extending from the second connection portion to the outside of the body, and
the first connection portion has a shape that maintains a turn of the turn formation portion.

34. The coil component of claim 33, wherein the second connection portion has a shape that maintains the turn of the turn formation portion.

35. The coil component of claim 33, wherein
the body has first and second surfaces opposing each other in the first direction, third and fourth surfaces opposing each other in a second direction, perpendicular to the first direction, and fifth and sixth surfaces opposing each other in a third direction, perpendicular to the first and the second directions, and
the first and the second lead frames extend to the first surface of the body, and are arranged in the second direction.

36. The coil component of claim 35, wherein the first and the second ends of the coil are disposed to be close to a corner where the fourth and the fifth surfaces of the body meet.

37. The coil component of claim 36, wherein the first connection portion and the second connection portion have different shapes.

38. A coil component comprising:
a body;
a coil disposed within the body, the coil including a turn formation portion;
a first lead frame connected to a first end of the coil, the first lead frame extending to an outside of the body; and
a second lead frame connected to a second end of the coil, the second lead frame extending to the outside of the body,
wherein at least one of the first and the second ends of the coil is positioned inside the turn formation portion.

39. The coil component of claim 38, wherein the first and the second ends of the coil are positioned inside the turn formation portion.

40. The coil component of claim 38, wherein the first end of the coil is positioned inside the turn formation portion, and the second end of the coil is disposed on an outside of the turn formation portion.
